(19) United States
(12) Patent Application Publication
(10) Pub. No.: US 2013/0191276 A1
(43) Pub. Date: Jul. 25, 2013

(54) MEDIA CONTENT SELECTION SYSTEM AND METHODOLOGY

(71) Applicant: MySpace, LLC, Beverly Hills, CA (US)

(72) Inventors: Timothy Charles Vanderhook, Newport Beach, CA (US); Jason J.A. Knapp, Solana Beach, CA (US); Brian C. DeFrancesco, Trabuco Canyon, CA (US); Christopher John Vanderhook, Yorba Linda, CA (US)

(73) Assignee: MYSPACE, LLC, Beverly Hills, CA (US)

(21) Appl. No.: 13/786,234

(22) Filed: Mar. 5, 2013

Related U.S. Application Data
(63) Continuation-in-part of application No. 13/744,716, filed on Jan. 18, 2013.
Application No. 13/744,716 is a continuation-in-part of application No. PCT/US13/22067, filed on Jan. 18, 2013.
(60) Provisional application No. 61/588,042, filed on Jan. 18, 2012.
(60) Provisional application No. 61/606,883, filed on Mar. 5, 2012.
(60) Provisional application No. 61/588,042, filed on Jan. 18, 2012.
(60) Provisional application No. 61/606,883, filed on Mar. 5, 2012.

(51) Int. Cl. G06F 3/0482

(52) U.S. Cl. CPC G06F 3/0482
USPC 705/39; 715/716

(57) ABSTRACT

A method, system, and computer program product provide a methodology for selecting media content. Pick percentages for how often each of two or more selection methodologies are used to select the media content are established. A request for media content is received. Based on the pick percentages, one of the two or more selection methodologies is selected to select media content. The selected media content is then played.

### CROSS-REFERENCE TO RELATED APPLICATIONS

This application is a continuation-in-part of and claims the benefit under 35 U.S.C. Section(s) 119, 120 and/or 365 to the following co-pending and commonly-assigned patent application(s), which is/are incorporated by reference herein:

U.S. patent application Ser. No. 13/744,716, entitled “MEDIA EXCHANGE PLATFORM”, by Timothy Charles Vanderhook, Jason J. A. Knapp, and Brian C. Defrancesco, filed on Jan. 18, 2013, Attorney Docket No. 257.9-US-U1, which application claims the benefit under 35 U.S.C. Section 119 to U.S. Patent Application Ser. No. 61/588,042, entitled “MEDIA EXCHANGE PLATFORM”, by Timothy Charles Vanderhook, Jason J. A. Knapp, and Brian C. Defrancesco, filed on Jan. 18, 2012 Attorney Docket No. 257.9-US-P1, and U.S. Patent Application Ser. No. 61/606,883, entitled “MEDIA CONTENT SELECTION SYSTEM AND METHODOLOGY”, by Timothy Charles Vanderhook, Jason J. A. Knapp, Brian C. DeFrancesco, and Christopher John Vanderhook, filed on Mar. 5, 2012, Attorney Docket No. 257.10-US-P1; and Patent Cooperation Treaty Patent Application no. PCT/US13/22067, entitled “MEDIA EXCHANGE PLATFORM”, by Timothy Charles Vanderhook, Jason J. A. Knapp, and Brian C. Defrancesco, filed on Jan. 18, 2013, Attorney Docket No. 257.9-WO-U1 which application claims the benefit under 35 U.S.C. Section 119 to U.S. Patent Application Ser. No. 61/588,042, entitled “MEDIA EXCHANGE PLATFORM”, by Timothy Charles Vanderhook, Jason J. A. Knapp, and Brian C. Defrancesco, filed on Jan. 18, 2012 Attorney Docket No. 257.9-US-P1, and U.S. Patent Application Ser. No. 61/606,883, entitled “MEDIA CONTENT SELECTION SYSTEM AND METHODOLOGY”, by Timothy Charles Vanderhook, Jason J. A. Knapp, Brian C. DeFrancesco, and Christopher John Vanderhook, filed on Mar. 5, 2012, Attorney Docket No. 257.10-US-P1.

### BACKGROUND OF THE INVENTION

1. Field of the Invention

The present invention relates generally to content delivery via an electronic network, and in particular, to a method, apparatus, and article of manufacture for determining how a media content player determines what content to play.

2. Description of the Related Art

In traditional Internet communications, a user requests a web page (via a link or by typing in a uniform resource locator (URL) in a web page). Alternatively, in a media player, a user may also request media content (e.g., music, video/audio, text, graphics, etc.). Such a request may be for a specific piece of media content (e.g., a particular song) or may be for a category of content (e.g., rock music). In response, a server is responsible for determining/selecting and delivering the content to the user. Traditionally, the particular content that is delivered to the user is either the specific content requested by the user or is selected via a single selection algorithm such as a collaborative filter algorithm. However, such a single selection algorithm fails to meet the flexibility and customization needed to deliver certain content to users. In this regard, certain content owners may be willing to incur additional charges for prioritized selection/delivery of their content. The prior art fails to provide a means for enabling such selection/delivery.

### SUMMARY OF THE INVENTION

Embodiments of the invention provide a methodology for selecting the content that will be delivered to a user/media player. Rather than relying on a single selection methodology, a payment by a third party (e.g., media content owner, a promoter, etc.) may be used to select specific media content some percentage of the time. The remaining percentage of the time, one or more different selection methodologies may be used (either alone or in combination) to select the content to be delivered/played. Such content that is delivered based on payment may be utilized to deliver content that is not “discovered” or has not been frequently played/requested by users (e.g., on radio stations, on-demand programming, the Internet, or other media content delivery means). Accordingly, embodiments of the invention provide a mechanism for users to learn about content that has not yet acquired sufficient traction to be delivered to a user based on a standard selection methodology (e.g., a collaborative filtering methodology).

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention;

FIG. 2 schematically illustrates a typical distributed computer system using a network to connect client computers to server computers in accordance with one or more embodiments of the invention;

FIG. 3 illustrates the flow of the media exchange platform in accordance with one or more embodiments of the invention; and

FIG. 4 is a flow chart illustrating the logical flow for selecting/discovering content in accordance with one or more embodiments of the invention

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Hardware Environment

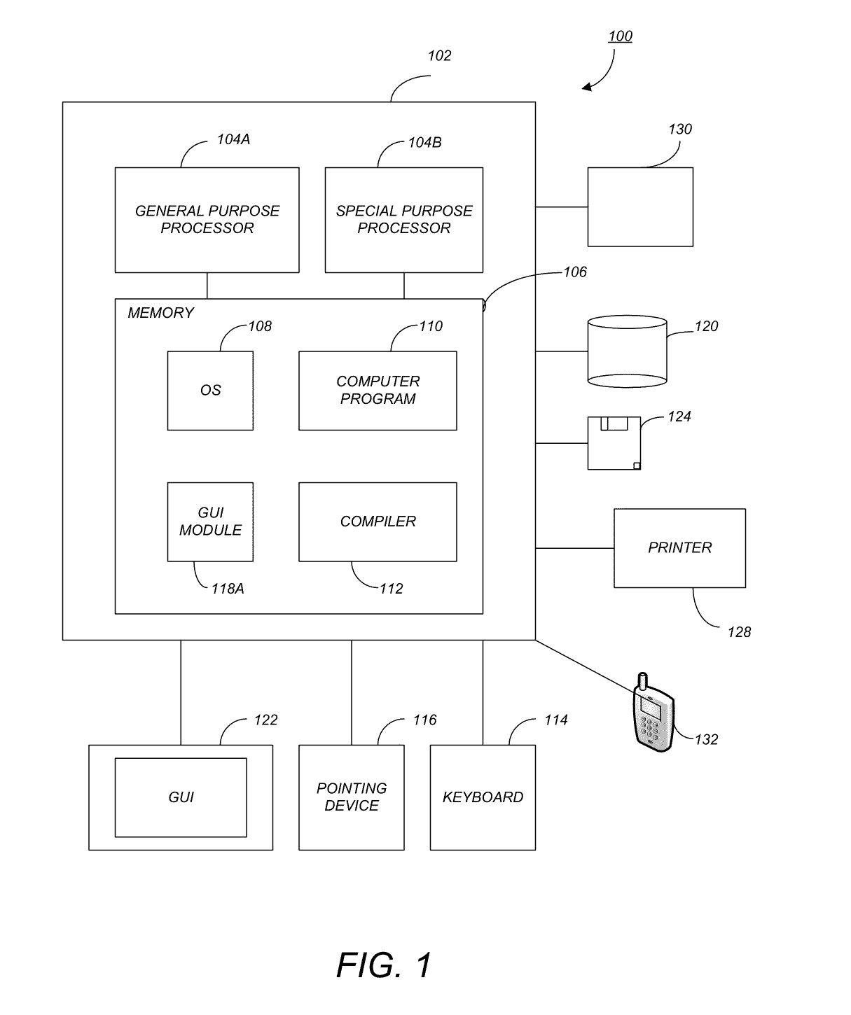

FIG. 1 is an exemplary hardware and software environment 100 used to implement one or more embodiments of the invention. The hardware and software environment includes a computer 102 and may include peripherals. Computer 102 may be a user/client computer, server computer, or may be a database computer. The computer 102 comprises a general purpose hardware processor 104A and/or a special purpose hardware processor 104B (hereinafter alternatively collectively referred to as processor 104) and a memory 106, such as random access memory (RAM). The computer 102 may comprise or may be coupled to and/or integrated with other devices, including input/output (I/O) devices such as a keyboard 114, a cursor control device 116 (e.g., a mouse, a pointing device, pen and tablet, touch screen, multi-touch device, etc.) and a printer 128. In one or more embodiments, computer 102 may be coupled to or may comprise a portable or media viewing/listening device 132 (e.g., an MP3 player, iPod™, Nook™, portable digital video player, cellular device, personal digital assistant, etc.). In yet another embodiment, the computer 102 may comprise a multi-touch device, mobile phone, gaming system, internet enabled television, television set top box, or other internet enabled device executing on various platforms and operating systems.

In one embodiment, the computer 102 operates by the general purpose processor 104A performing instructions defined by the computer program 110 under control of an operating system 108. The computer program 110 and/or the operating system 108 may be stored in the memory 106 and may interface with the user and/or other devices to accept input and commands and, based on such input and commands and the instructions defined by the computer program 110 and operating system 108 to provide output and results.

Output/results may be presented on the display 122 or provided to another device for presentation or further processing or action. In one embodiment, the display 122 comprises a liquid crystal display (LCD) having a plurality of separately addressable liquid crystals. Alternatively, the display 122 may comprise a light emitting diode (LED) display having clusters of red, green and blue diodes driven together to form full-color pixels. Each liquid crystal or pixel of the display 122 changes to an opaque or translucent state to form a part of the image on the display in response to the data or information generated by the processor 104 from the application of the instructions of the computer program 110 and/or operating system 108 to the input and commands. The image may be provided through a graphical user interface (GUI) module 118A. Although the GUI module 118A is depicted as a separate module, the instructions performing the GUI functions can be resident or distributed in the operating system 108, the computer program 110, or implemented with special purpose memory and processors.

In one or more embodiments, the display 122 is integrated with/into the computer 102 and comprises a multi-touch device having a touch sensing surface (e.g., track pod or touch screen) with the ability to recognize the presence of two or more points of contact with the surface. Examples of a multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 102 according to the computer program 110 instructions may be implemented in a special purpose processor 104B. In this embodiment, some or all of the computer program 110 instructions may be implemented via firmware instructions stored in a read only memory (ROM), a programmable read only memory (PROM) or flash memory within the special purpose processor 104B or in memory 106. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program instructions. In one embodiment, the special purpose processor is an application specific integrated circuit (ASIC).

The computer 102 may also implement a compiler 112 which allows an application program 110 written in a programming language such as COBOL, Pascal, C++, FORTRAN, or other language to be translated into processor 104 readable code. Alternatively, the compiler 112 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 110 accesses and manipulates data accepted from I/O devices and stored in the memory 106 of the computer 102 using the relationships and logic that was generated using the compiler 112.

The computer 102 also optionally comprises an external communication device such as a modem, satellite link, Ethernet card, or other device for accepting input from and providing output to other computers 102.

In one embodiment, instructions implementing the operating system 108, the computer program 110, and the compiler 112 are tangibly embodied in a non-transient computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of computer program instructions which, when accessed, read and executed by the computer 102, causes the computer 102 to perform the steps necessary to implement and/or use the present invention or to load the program of instructions into a memory, thus creating a special purpose data structure causing the computer to operate as a specially programmed computer executing the method steps described herein. Computer program 110 and/or operating instructions may also be tangibly embodied in memory 106 and/or data communications devices 130, thereby making a computer program product or article of manufacture according to the invention. As such, the terms “article of manufacture,” “program storage device” and “computer program product” as used herein are intended to encompass a computer program accessible from any computer readable device or media.

Of course, those skilled in the art will recognize that any combination of the above components, or any number of different components, peripherals, and other devices, may be used with the computer 102.

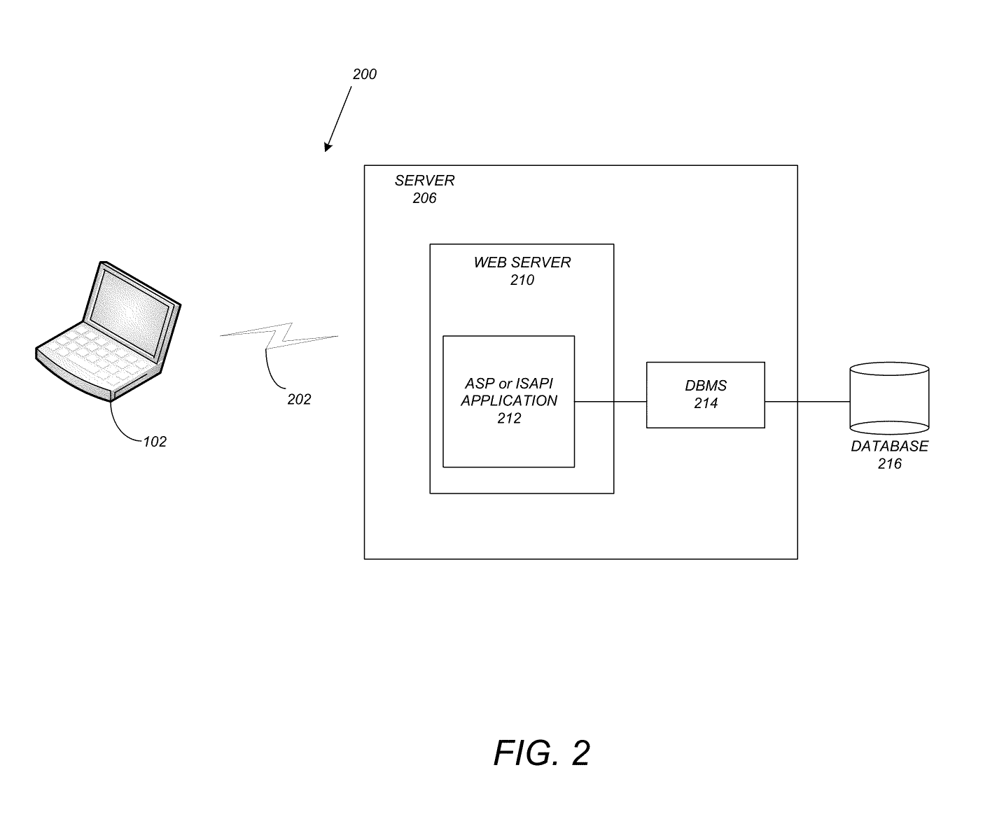

FIG. 2 schematically illustrates a typical distributed computer system 200 using a network 202 to connect client computers 102 to server computers 206. A typical combination of resources may include a network 202 comprising the Internet, LANs (local area networks), WANs (wide area networks), SNA (systems network architecture) networks, or the like, clients 102 that are personal computers or workstations, and servers 206 that are personal computers, workstations, minicomputers, or mainframes (as set forth in FIG. 1). However, it may be noted that different networks such as a cellular network (e.g., GSM [global system for mobile communications] or otherwise), a satellite based network, or any other type of network may be used to connect clients 102 and servers 206 may be utilized for embodiments of the invention.

A network 202 such as the Internet connects clients 102 to server computers 206. Network 202 may utilize ethernet, coaxial cable, wireless communications, radio frequency (RF), etc. to connect and provide the communication between clients 102 and servers 206. Clients 102 may execute a client application or web browser and communicate with server computers 206 executing web servers 210. Such a web browser is typically a program such as MICROSOFT INTERNET EXPLORER™, MOZILLA FIREFOX™, OPERA™, APPLE SAFARI™, GOOGLE CHROME™, etc. Further, the software executing on clients 102 may be downloaded from server computer 206 to client computers 102 and installed as a plug in or ACTIVEX™ control of a web browser. Accordingly, clients 102 may utilize ACTIVEX™ components/component object model (COM) or distributed COM (DCOM) components to provide a user interface on a display of client 102. The web server 210 is typically a program such as MICROSOFT'S INTERNET INFORMATION SERVER™.

Web server 210 may host an Active Server Page (ASP) or Internet Server Application Programming Interface (ISAPI) application 212, which may be executing scripts. The scripts invoke objects that execute business logic (referred to as business objects). The business objects then manipulate data in database 216 through a database management system (DBMS) 214. Alternatively, database 216 may be part of or connected directly to client 102 instead of communicating/obtaining the information from database 216 across network 202. When a developer encapsulates the business functionality into objects, the system may be referred to as a component object model (COM) system. Accordingly, the scripts executing on web server 210 (and/or application 212) invoke COM objects that implement the business logic. Further, server 206 may utilize MICROSOFT'S™ Transaction Server (MTS) to access required data stored in database 216 via an interface such as ADO (Active Data Objects), OLE DB (Object Linking and Embedding DataBase), or ODBC (Open DataBase Connectivity).

Generally, these components 200-216 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the term “user computer”, “client computer”, and/or “server computer” is referred to herein, it is understood that such computers 102 and 206 may include thin client devices with limited or full processing capabilities, portable devices such as cell phones, notebook computers, pocket computers, multi-touch devices, and/or any other device with suitable processing, communication, and input/output capability.

Of course, those skilled in the art will recognize that any combination of the above components, or any number of different components, peripherals, and other devices, may be used with computers 102 and 206.

### Media Exchange Platform Overview

Embodiments of the invention are implemented as a software application (i.e., a media exchange platform [MEP]) executing on a client 102, server computer 206, or a combination of both client 102 and server 206. Further, as described above, the client 102 or server computer 206 may comprise a thin client device or a portable device that has a multi-touch-based display (i.e., a tablet device), a mobile phone, a gaming system, an IP (internet protocol) enabled television, a television set top box, or other internet enabled device running on various platforms and operating systems.

The MEP is a platform that enables real time buying and selling of content exposure and media consumption. The sellers are internet properties operating websites or applications with dynamic media streaming or dynamic content displayed. The buyers are artists, producers, performers, entertainers, advertisers, or other parties who create or represent creators of content or media that would like to promote their content (media) by driving increased exposure through paying for consumption (exposure) to target audiences. Media can be music, video, or any multimedia digital streaming format. Content can be text and/or graphic based including articles, links, images, animations, etc.

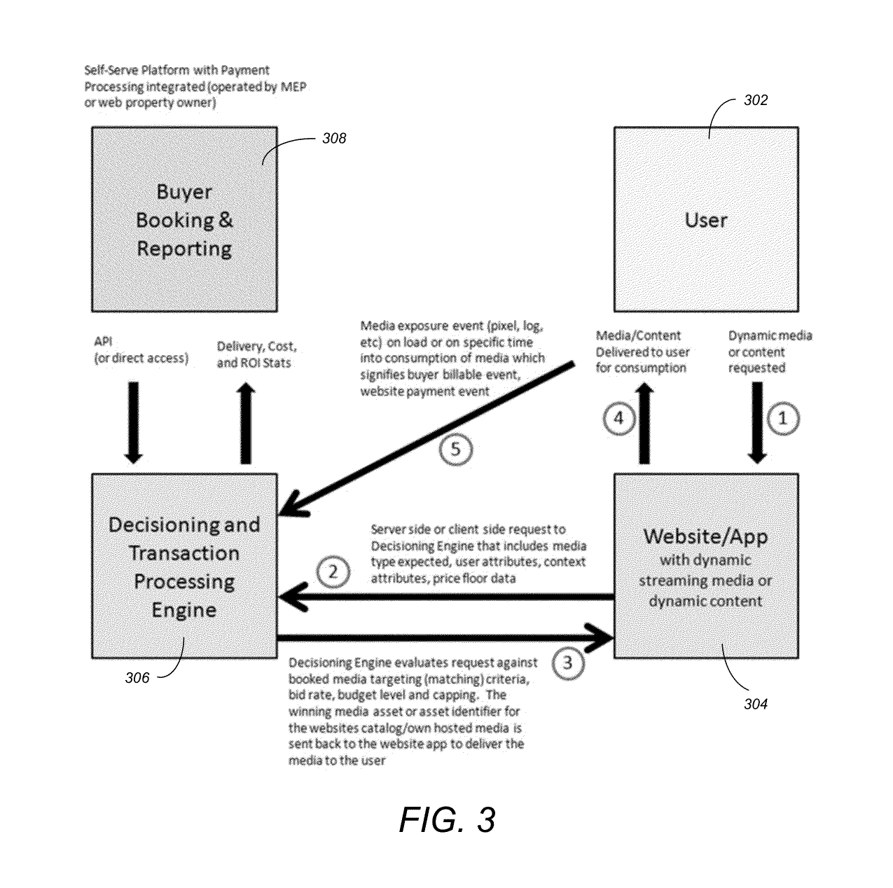

FIG. 3 illustrates the flow of the media exchange platform in accordance with one or more embodiments of the invention.

As illustrated, the first step (1) is that of the user 302 (e.g., client 102) requesting dynamic media or content from a website/application 304 (e.g., server 206).

In response, at (2), the website/application 304 conducts a server side or client side request to a decisioning engine 306. The request includes the media type expected, the user attributes, the context attributes, and price floor data. In reply, at (3), the decisioning engine 306 evaluates the request against booked media targeting (matching) criteria, bid rate, budget level, and capping. The winning media asset or asset identifier for the websites/catalog/own hosted media is sent back to the website application 304 to deliver the media to the user 302.

Thus, as illustrated at arrow (4), the media/content is delivered to the user for consumption. In addition, at (5), the media exposure event may be transmitted from the user 302 to the decisioning engine 306. Such a media exposure event may comprise a pixel, a log, etc. that is delivered to the decisioning engine 306 when the media/content is loaded, or at a specific time into the consumption of the media. Such a media exposure event signifies that a buyer billable event/website payment event has occurred. Accordingly, the media exposure event is used to track when the media has been consumed by the user 302 thereby requiring payment from the buyer 308.

In addition to steps (1)-(5) described above, the decisioning engine 306 may conduct interactions with the buyer booking and reporting engine 308 in order to manage and obtain the content to be delivered to the website/application 304. In this regard, the buyer booking and reporting component may be a self-serve platform with payment processing integrated. Further, the engine 308 may be operated by/part of the MEP or a web property owner.

To enable the buyer booking and reporting component 308 to provide content, the buyer booking and reporting component 308 accesses the decision engine 306 directly or via an application programming interface (API). The content may also be uploaded either directly through the booking engine 308 and then transferred into the decisioning platform 306 from the API or via direct access between the two systems 306 and 308. Alternatively, the content may be uploaded to/on the website 304 and the buyer inputs the website's content identifier (i.e., unique id).

To inform the buyer 308 of which media has been consumed (and to provide an accounting), the decisioning engine 306 may provide the delivery, cost, and return on investment (ROI) statistics to the buyer 308.

### Content Selection

The various components 302-308 enable the media exchange platform. Co-pending application Ser. No. 13/744,716 describes some of the detailed functionality for the individual components 302-308. Embodiments of the present invention are directed towards determining how and when the content is selected, and in particular how “undiscovered” content is dealt with.

Both decisioning engine 306 and a media player executed by the user 302 may control/determine what content to play and when. As part of such a determination, embodiments of the invention provide a mechanism/methodology for the decisioning engine 306 and/or the player to learn about content that hasn't achieved sufficient traction/popularity to be “discovered” or selected by a regular selection methodology (e.g., collaborative filtering).

As used herein, the user 302 is a person visiting a website or using a web based application to consume content or media (i.e., via a client device 102) and may execute a media content player (e.g., to play audio, video, audio/video, text, graphics, etc.).

Users 302 may request (e.g., load into a media player) specific media content. However, at various times, a user 302 may request media content without specifying which content he/she desires to play. Alternatively, the user 302 may request a general category of media content. For example, a user may select a “radio” channel or “movie” channel without specifying a particular song, album, or movie. Alternatively, the user 302 may “tune into” a particular channel or specify a particular genre of music/movie (e.g., alternative rock or horror films). In yet another embodiment, the user 302 may play a particular piece of media content and upon completion of play, may not specify any further parameters but may desire to play similar content (e.g., may desire to listen to the radio after a specifically selected song completes playing).

In view of the above, embodiments of the invention provide a mechanism and methodology for selecting the content to be played. Such a selection may occur within the decisioning engine 306 or by the media player executed by the user 302. In the prior art, a single selection methodology (e.g., collaborative filtering) was used to determine the content to be played. However, such prior art methodologies fail to provide the capability to select content that is “undiscovered” (e.g., not “popular”). In other words, if some new content has not entered/achieved mainstream distribution/play, such content will not be selected for play by traditional prior art content selection systems.

Rather than relying on a particular method for selecting the content, embodiments of the invention may utilize a combination of multiple different selection methodologies. For example, instead of relying exclusively on a collaborative filtering algorithm to select the content, a combination of the collaborative filtering algorithm with another methodology may be utilized. In this regard, embodiments of the invention may utilize a collaborative filtering system to select content eighty percent (80%) of the time, and selecting content based on payment from a content owner/buyer the remaining twenty percent (20%) of the time. The content selected twenty percent of the time may be content that is not normally provided and may be marked as a sponsored song (e.g., by the website/application 304 or when played by the user 302).

More than two different selection methodologies may also be utilized. For example, the following combination may be utilized:
80% of the time: based on the user's preferences (e.g., based on what the user may like);
10% of the time: based on a pay for play (where the content owner pays to have the owner's content delivered/viewed by the user); and
10% of the time: based on a learning algorithm (e.g., a song that is trending in the correct genre to see if the user likes the song or not).

Eventually, a song played for payment may be included in a collaborative filtering selection system (e.g., if multiple users indicate a like/preference for such a song). In addition, the user experience may be managed by setting conditions on how often the pay for play may occur. Such a pay for play system may allow a media content owner/promoter to help undiscovered talent/artists that haven't yet signed with a “label” receive more airtime for their content (e.g., music, video, etc.). There may also be a combination of pay-for-play with other features. For example, a buyer may prefer to pay for the play of his/her content only when the user 302 has a preference for content in the same genre (e.g., rock music) and/or if certain content is “trending” or has recently become popular (e.g., is a viral video or if the user 302 can be seen to be viewing similar content in the user's current viewing session rather than merely shopping [e.g., the engine 306 may be attempting to predict the current user's 302 mood for exposure to particular media content]). Thus, each of the different selection methodologies may be utilized independently from or in combination with other selection methodologies to optimize the user 302 experience with such content.

The percentages and use of different selection methodologies may also be modified dynamically on the fly as more content is received by/viewed by the user 302. For example, the time of day, user profile, current user's response to particular content, internet speed, etc. (any type of attribute) may be used to adjust the percentages for which each selection methodology is used to select content. For example, suppose a pay-for-play selection is used eighty percent (80%) of the time and based on such a methodology, a particular song is recommended to a user, who in response indicates a “like” for such content. In such a circumstance, the system may increase the percentage of time that pay-for-play is used up for that user/class/type of user (e.g., based on an assumption that this user likes to receive recommendations and may have a positive experience for such content). Similarly, if a user skips all pay-for-play content whenever presented to a user without further input, embodiments of the invention may decrease the percentage of time that pay-for-play content is provided to such a user.

Such adjustments to the percentages of time a particular selection methodology is used may be performed dynamically based on a set (predefined or otherwise) of rules/preferences or may be adjusted based on an evaluation of the success failure of a particular combination/percentages from the view of the engine 306, user 302, website 304, and/or content owner/buyer.

In view of the above, embodiments of the invention may utilize a content selection methodology that switches between a collaborative filter pick based on the last song the user chose, and picking unsigned artists that wouldn't have had enough plays to be selected by the collaborative filter methodology (e.g., a “learning” mode that tries out new songs/artists based just on the genre).

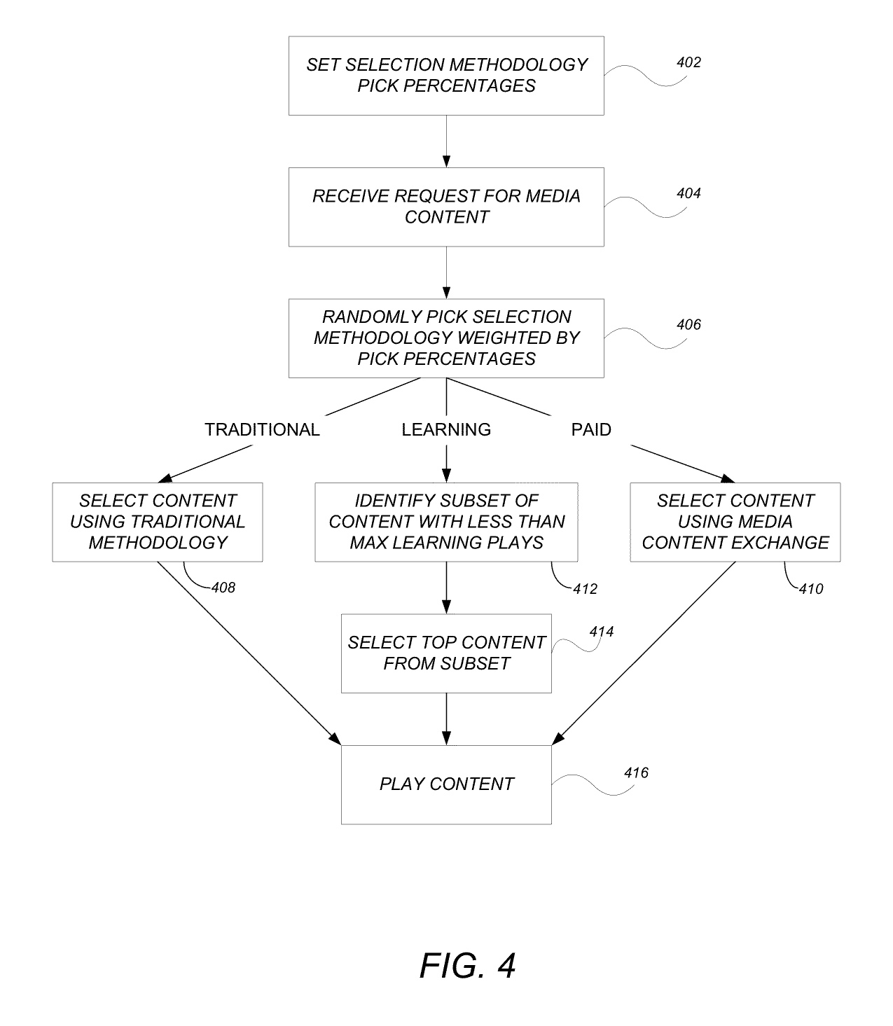

FIG. 4 is a flow chart illustrating the logical flow for selecting/discovering content in accordance with one or more embodiments of the invention. At step 402, the pick percentages for how often certain selection methodologies are used to select content are established/set. For example, if three different methodologies are used, three different percentages may be specified: (1) a first percentage represents the percentage of the content plays that will potentially go towards the discovery of new content (e.g., a LEARNINGPICK percentage); (2) a second percentage represents the percentage of the content plays that will utilize a paid methodology to pay for play of content (e.g., a PAIDPICK percentage); (3) a third percentage represents the percentage of the content plays that utilize a traditional selection methodology such as collaborative filtering (e.g., an EXECUTIONPICK percentage).

At step 404, a request for media content is received (e.g., from a media content player).

At step 406, upon each song selection, a selection methodology weighted by the pick percentages (e.g., learning, paid, or execution) is randomly selected. One may note that rather than randomly selecting the content selection methodology for every request, embodiments of the invention may wait until after a certain number (“X”) of media content has been selected. The value of X may be a STARTINGNUM and content selected before reaching the STARTINGNUM may only utilize a single selection methodology (e.g., EXECUTIONPICK) may be used.

If the execution pick/traditional methodology is randomly selected, the traditional methodology for selecting media content is used at step 408. Such a methodology may pick the media content (e.g., song) that the system thinks will be best for the user. Such a selection may depend on the mode. For example, if the media content player proceeds to a radio mode based on a song, a collaborative filter may be used that is based on the starting song (if there is enough data). Alternatively, if there is not enough play data to collaborate (i.e., from multiple users), the top played songs in the same song genre (as the song previously played) may be selected. If the system desires to play radio for a particular artist, the artist's featured song may be played, then the artist's entire catalog may be played in order of popularity.

If the paid selection methodology is selected, content may be selected using then media content exchange at step 410 (i.e., as described in co-pending application 13/744,716 which is incorporated by reference herein).

If the learning methodology is picked, the subset of media content with less that a maximum number of learning plays (MAXLEARNINGPLAYS) may be identified at step 412. The top content (e.g., top-rated content, or most played content) may be selected from that subset at step 414 and played at step 416.

In an example of the learning methodology, a song of the same genre (as a recently/last played song) that has been played less than MAXLEARNINGPLAYS may be selected. To select such a song, the top NUMLEARNING played songs that have not been played more than MAXLEARNINGPLAYS may be picked (e.g., if NUMLEARNING=50 and there are 10,000 songs of the genre with less than MAXLEARNINGPLAYS, a song may be picked from the top fifty (50) most played of that 10,000).

In other words, songs that are not yet “discovered” are identified by a NUMLEARNING statistic/property that represents the number of times that song has been played. With each play, the system collects more data and increases the NUMLERARNING value for a song. Once the NUMLEARNING value reaches or exceeds the MAXLEARNINGPLAYS value, it is assumed that the system has theoretically collected enough data that the song should play using the traditional methodology (e.g., the EXECUTIONPICK) without needing more plays from the LEARNINGPICK methodology.

In addition, data may be collected and refined that defines genres, such as multiple genres (possibly in a rank order of best match, or in a tree structure such as Rock>Alternative Rock), or data indicating that a particular song is “similar to” a list of other songs. Such data may be supplied by users 302 or an external data provider.

In addition, the MAXLEARNINGPLAYS parameter may be more sophisticated/intelligent by analyzing a content library to determine when a song has made connections within the execution methodologies (e.g., when a song is being selected by the traditional selection methodology) rather than using a static number.

Further, users may be asked for feedback (e.g., thumbs down and thumbs up) relating to the suggestion/selected content. Enough negative feedback prior to reaching MAXLEARNINGPLAYS may be considered in blocking that song from being played at all using learning, or blocked for a particular category, song association, or other mechanism. Similarly, positive feedback may also be considered the traditional/execution methodology.

Once selected, the chosen media content is played by the user 302 (or other entity) at step 416.

Conclusion

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method of selecting media content comprising:
establishing pick percentages for how often each of two or more selection methodologies are used to select the media content;
receiving a request for media content;
selecting, based on the pick percentages, one of the two or more selection methodologies to select media content; and
playing the selected media content.

2. The method of claim 1 wherein one of the two or more selection methodologies comprises a collaborative filter.

3. The method of claim 1 wherein one of the two or more selection methodologies comprises a methodology for discovering new media content that the user has not previously received.

4. The method of claim 1 wherein one of the two or more selection methodologies comprises a learning methodology comprising:
identifying a subset of the media content with less than a maximum number of plays; and
selecting the media content from the subset.

5. The method of claim 4 wherein the learning methodology further comprises:
blocking media content from selection based on negative user feedback.

6. The method of claim 1 wherein one of the two or more selection methodologies comprises a pay-for-play methodology wherein compensation is received for playing the media content.

7. The method of claim 1 wherein the request for media content is received from a media content player.

8. The method of claim 1 wherein the selecting one of the two or more selection methodologies comprises:
weighting the two or more selection methodologies by the pick percentages; and
randomly selecting one of the two or more weighted selection methodologies.

9. The method of claim 1 wherein the selecting one of the two or more selection methodologies comprises:
utilizing one of the two or more selection methodologies for a defined number of media content requests; and
utilizing a second of the two or more selection methodologies for media content requests beyond the defined number.

10. A system of selecting media content comprising:
(a) a computer having a processor;
(b) an application executed by the processor, wherein the application is configured to:
(1) establish pick percentages for how often each of two or more selection methodologies are used to select the media content;
(2) receive a request for media content;
(3) select, based on the pick percentages, one of the two or more selection methodologies to select media content; and
(4) play the selected media content.

11. The system of claim 10 wherein one of the two or more selection methodologies comprises a collaborative filter.

12. The system of claim 10 wherein one of the two or more selection methodologies comprises a methodology for discovering new media content that the user has not previously received.

13. The system of claim 10 wherein one of the two or more selection methodologies comprises a learning methodology comprising:
identifying a subset of the media content with less than a maximum number of plays; and
selecting the media content from the subset.

14. The system of claim 13 wherein the learning methodology further comprises:
blocking media content from selection based on negative user feedback.

15. The system of claim 10 wherein one of the two or more selection methodologies comprises a pay-for-play methodology wherein compensation is received for playing the media content.

16. The system of claim 10 wherein the request for media content is received from a media content player.

17. The system of claim 10 wherein the application is configured to select one of the two or more selection methodologies by:
weighting the two or more selection methodologies by the pick percentages; and
randomly selecting one of the two or more weighted selection methodologies.

18. The system of claim 10 wherein the application is configured to select one of the two or more selection methodologies by:
utilizing one of the two or more selection methodologies for a defined number of media content requests; and
utilizing a second of the two or more selection methodologies for media content requests beyond the defined number.
